(19) United States
(12) Patent Application Publication
(10) Pub. No.: US 2026/0088646 A1
(43) Pub. Date: Mar. 26, 2026

(54) SMART POWER DISTRIBUTION AND DEVICE MANAGEMENT SYSTEM

(71) Applicant: Victor Manuel Menendez, JR., Mckinney, TX (US)

(72) Inventor: Victor Manuel Menendez, JR., Mckinney, TX (US)

(21) Appl. No.: 19/332,232

(22) Filed: Sep. 18, 2025

Related U.S. Application Data
(60) Provisional application No. 63/697,715, filed on Sep. 23, 2024.

(51) Int. Cl. H02J 7/00; H02J 3/00; H02J 3/28; H02J 50/30

(52) U.S. Cl. CPC H02J 7/92; H02J 3/0012; H02J 3/003; H02J 3/28; H02J 50/30; H02J 2103/30; H02J 2105/12

(57) ABSTRACT

A power management system that optimizes energy distribution for motorized shades and low-power devices through integrated energy storage, dynamic power allocation, and multiple charging methods. Featuring a smart battery management system (BMS) with AI-driven control, the system enables real-time monitoring and predictive analytics to enhance efficiency. It supports wired, wireless, and beam-forming power transfer technologies, allowing for flexible installations. Integrated safety mechanisms prevent unauthorized device usage and system overloads. The invention offers scalability and adaptability for various applications, including home automation, electric vehicles, renewable energy systems, and more.

### BACKGROUND

The embodiments herein relate generally to power management systems and more particularly to a smart power distribution and device management system.

Conventional motorized shade systems and low-power devices often rely on large, individual power supplies or Power over Ethernet (PoE) switches. This approach leads to inefficient energy use, increased costs, and complex installations due to extensive wiring and the need for dedicated power sources for each device. Existing systems lack the ability to dynamically manage the energy demands of multiple devices or to optimize power usage during off-peak periods. Additionally, they offer limited flexibility in installation options, making it challenging to adapt to varying environments or to incorporate emerging technologies like wireless power transfer.

### SUMMARY

Embodiments of the subject technology, provide an innovative solution for efficient power management across multiple devices. By integrating a Smart Battery Management System (BMS) with Al-driven control, the system dynamically distributes power based on real-time demand and predictive usage patterns.

Key Features include:

Energy Storage and Timed Charging: Allows a smaller power supply (e.g., 60 watts) to manage multiple devices by leveraging integrated energy storage within each device. Devices are charged based on real-time demand and scheduled cycles, optimizing energy usage and reducing the need for large, continuous power supplies.

Flexible Charging Methods: Supports wired charging, wireless inductive charging, and beam-forming power transfer technologies (e.g., infrared or laser-based systems). Provides flexibility for different installation environments, reducing wiring complexity and enabling wireless power transfer between devices.

Optimized Power Distribution: The Smart BMS dynamically allocates power based on each device's needs, preventing overloads and ensuring efficient energy use. Utilizes predictive analysis to prioritize energy distribution, ensuring critical devices receive power when necessary.

Mesh Communication Network: Employs a Mesh Network to facilitate real-time communication between the BMS and connected devices. Enables efficient coordination of device charging and power use, enhancing system scalability and reliability.

Integrated Safety Features: A Manual Logic Alert System monitors the power supply and connected devices for unrecognized or incompatible components. Prevents unauthorized devices from consuming power and alerts users to potential issues, ensuring safe and reliable operation. The smart power source may continuously monitor devices connected to the system, identifying authorized devices through a query to the Battery Management System (BMS). If an unauthorized device is detected on the bus, whether due to an unexpected device drawing power or an anomaly in power usage, the system's algorithm flags the issue. Instead of restricting power, the system notifies the end user and prevents unauthorized smart devices from connecting. This may ensure that only approved devices are permitted to draw power, maintaining system integrity without interrupting authorized power flows.

Beam-Forming Power Unit: Facilitates wireless energy transfer between devices using infrared (IR) or laser technology. Prioritizes power transfer to critical devices in emergencies, reallocating energy without external charging.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a smart power distribution and device management system configuration, according to an embodiment.

FIG. 2 is a schematic view of a smart battery management system (BMS) and its connections to various devices, consistent with embodiments.

FIG. 3 is a block diagram of a mesh network, showing communication pathways between devices and the BMS of FIG. 2, consistent with embodiments.

FIG. 4 is a diagrammatic view of a beam-forming power unit demonstrating wireless energy transfer between devices, consistent with embodiments.

FIG. 5 is a block diagram of a manual logic alert system in relation to the power supply and connected devices, consistent with embodiments.

### DETAILED DESCRIPTION OF CERTAIN EMBODIMENTS

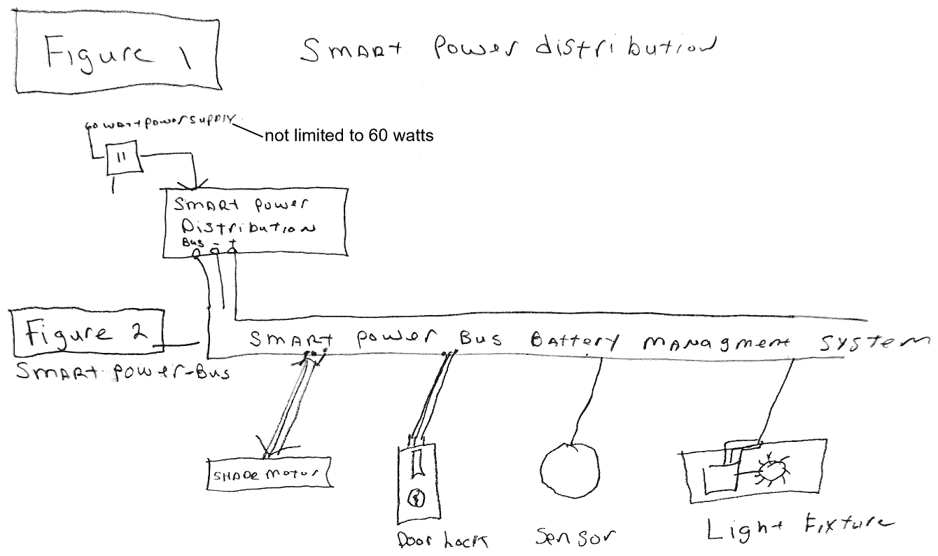

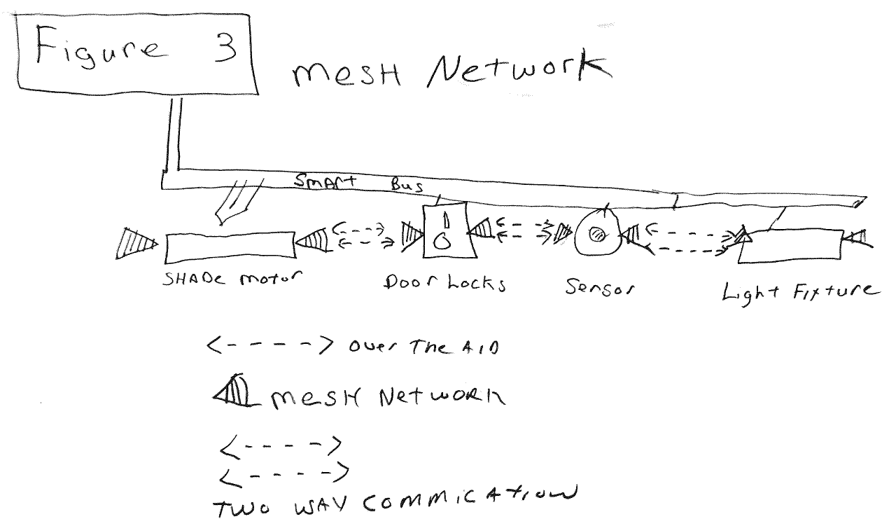

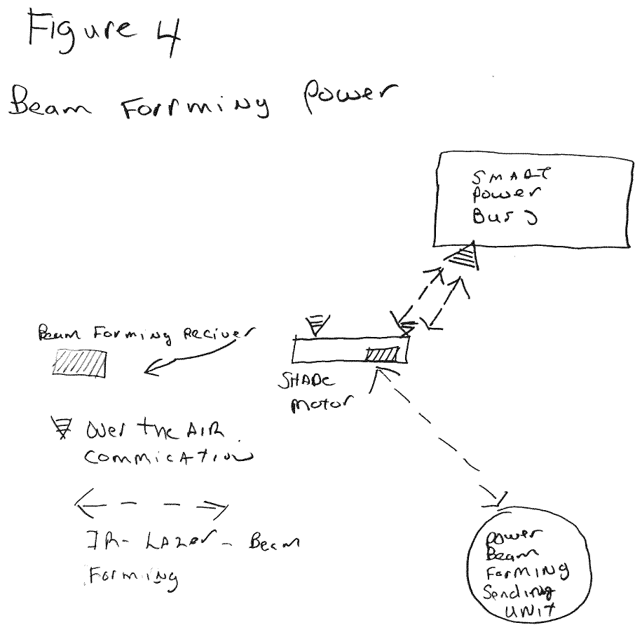

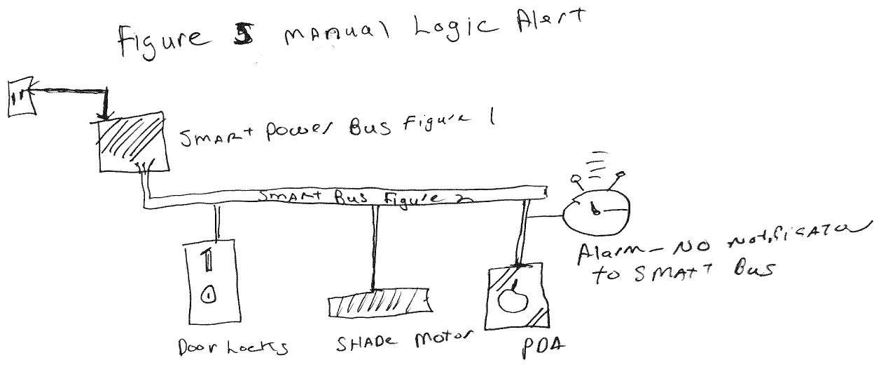

In general, the embodiments disclosed below optimize power management for motorized shades and various low-power devices. The system reduces reliance on large, dedicated power supplies by integrating intelligent energy storage, dynamic power distribution, and flexible charging methods. In an exemplary embodiment, (FIG. 4) motorized shades are connected to the system through a network. The re-charging and discharging of batteries in the motorized shades are controlled through a smart battery management system (BMS), which can be seen in FIGS. 1-3 and 5. In other embodiments, a variety of low-power electronic devices may have their power supplies controlled through the battery management and power transfer technologies disclosed herein. Some examples of low-powered devis include sensors, electronic door locks, and keypads.

As shown generally throughout the figures, the key components and their roles of the system include:

Power Supply Unit (PSU), which Serves as the primary power source and delivers energy to the System Bus, which supplies connected devices based on their real-time energy needs. Smart Battery Management System (BMS), which: acts as the control hub, monitoring power levels and managing charging cycles; dynamically allocates power and stores energy in device batteries during low-demand periods; and utilizes Al-driven algorithms to optimize power distribution.

The Smart Battery Management System (BMS) serves as the central control hub for managing power levels and charging cycles across connected devices. The BMS continuously monitors each device's power consumption and battery status in real-time, dynamically adjusting power distribution to optimize system efficiency.

Dynamic allocation refers to the system's ability to intelligently distribute power based on current demand and future predictions. For example, during periods of low energy demand, the BMS directs excess power to charge device batteries or store energy for later use. This reduces strain on the power supply during peak demand periods. If a connected device suddenly requires more power due to an increase in activity or function, the BMS dynamically reallocates stored energy to meet this new demand without affecting other devices on the system.

Furthermore, the system employs Al-driven algorithms that learn the typical usage patterns of each device, optimizing power delivery based on historical data and predicted usage trends. For instance, if the BMS recognizes that certain devices usually have high power consumption in the evening, it will preemptively charge those device batteries during off-peak times, ensuring sufficient power reserves are available when needed.

This method of dynamic allocation is unique in that it not only responds to immediate power demands but also anticipates future needs, optimizing overall system performance while reducing energy waste. The BMS further distinguishes itself by detecting unauthorized devices attempting to draw power and preventing them from connecting, thereby maintaining the security and integrity of the power distribution system.

Integrated Energy Storage (Batteries): Each connected device is equipped with an integrated battery. The batteries store energy supplied by the BMS, allowing devices to operate independently of continuous external power, and enable charging during off-peak times to ensure sufficient power during high-demand periods.

System Bus: This feature provides a conduit for wired power distribution and communication. The bus links the PSU, BMS, and all connected devices.

Mesh Network: A mesh network facilitates real-time communication between the BMS and each connected device. Also, it ensures efficient coordination of device charging and power use. The network supports scalability and adaptability of the system.

Charging Methods:

Wired charging uses traditional wired connections through the System Bus. Some embodiments include wireless inductive charging which allows devices to charge without direct physical connections.

Beam-Forming Power Transfer, is a feature that uses IR or laser technology to transfer energy wirelessly between devices.

Photovoltaic receivers, may be embedded within devices to capture and convert beam-forming energy into usable power. The photovoltaic receivers adjust to varying beam intensities and environmental conditions for consistent energy capture.

Manual Logic Alert System, that monitors the PSU and connected devices for unrecognized or incompatible components. The alert system triggers alerts if unauthorized devices are detected or if power demand exceeds PSU capacity. The alert system works in tandem with the Al-driven control hub to prevent system overload and ensure safe operation.

Beam-Forming Power Unit, is a device that enables wireless energy transfer between devices, bypassing the System Bus when necessary. The beam-forming unit uses IR or laser technology to direct energy precisely between devices. In some embodiments, the beam-forming unit may be managed by the Al-driven control hub for optimized power sharing.

### Beam-forming Power Unit

The Beam-Forming Power Unit is a specialized device designed to enable precise wireless energy transfer between interconnected devices, selectively bypassing the System Bus when advantageous. This unit is integral to optimizing energy distribution in smart environments and interfaces seamlessly with various devices, including:

Smart Shades: Automated window coverings that adjust based on environmental conditions or user preferences.

Low-Powered loT Devices: Such as sensors, smart lighting systems, thermostats, and other connected devices that require minimal energy to operate.

Portable Electronics: Including smartphones, tablets, and wearables that benefit from efficient wireless charging.

Home Automation Systems: Devices that manage various aspects of smart home environments, including security, climate control, and entertainment systems.

Energy-Hungry Appliances: Select appliances that may require higher power inputs during specific operations, such as smart refrigerators and HVAC systems.

### Technological Framework

The Beam-Forming Power Unit utilizes advanced infrared (IR) and laser technologies to direct energy beams with high precision and minimal loss. Key features include:

### Infrared (IR) Technology:

Emission and Reception: Uses IR LEDs or laser diodes to emit focused energy beams toward targeted devices.

Modulation: Energy beams are modulated to ensure accurate targeting while preventing interference with other devices.

Safety Mechanisms: Incorporates sensors to detect obstacles, automatically adjusting the beam to maintain safe operation.

### Laser Technology:

Precision Targeting: Employs laser diodes to create highly directional energy beams, facilitating efficient energy transfer.

Adaptive Optics: Integrates lens systems that adjust the focus of the laser beam based on real-time feedback.

Power Regulation: Features built-in mechanisms to adjust energy output according to the connected devices'requirements.

### Operational Mechanisms:

Managed by the Al-driven Smart Battery Management System (BMS), the Beam-Forming Power Unit operates through the following workflow:

Real-Time Monitoring:

Continuously scans connected devices to assess power needs and status.

Evaluates current and projected energy requirements based on usage patterns.

### Dynamic Energy Allocation:

Directs energy beams to devices experiencing increased demand, such as smart shades adjusting for sunlight.

Assigns priority levels to devices to ensure essential operations are supported.

Predictive Power Management:

Utilizes Al algorithms to predict future energy needs based on historical data, allowing for proactive energy allocation.

Adapts to changing usage patterns over time, optimizing resource distribution.

Security and Integrity:

Identifies unauthorized devices attempting to draw power and utilizes advanced authentication protocols to block them.

Sends notifications to users regarding unauthorized access attempts while maintaining authorized power flows.

### Example Scenario

In a smart home environment, the Beam-Forming Power Unit detects that smart shades require additional power to block sunlight while other low-powered loT devices operate simultaneously.

The unit directs an IR-based energy beam specifically to the shades, ensuring they receive the necessary power without disrupting the operation of other devices.

The Al-driven BMS anticipates an upcoming increase in usage for portable electronics during the evening and preemptively charges their batteries during low-demand periods.

If an unauthorized device attempts to connect, the Beam-Forming Power Unit identifies the anomaly and notifies the user, preventing any unauthorized power draw.

### Advantages and Novelty

The Beam-Forming Power Unit offers several distinct advantages: Precision Energy Transfer: Ensures targeted energy delivery with minimal loss, enhancing overall efficiency. Seamless Al Integration: Works in tandem with the Al-driven BMS for intelligent, adaptive power distribution. Enhanced Security: Detects and prevents unauthorized access to the power system, maintaining integrity without interrupting authorized devices. Scalability:

Interfaces with a wide range of devices, making it adaptable to various smart environments.

Predictive Management: Utilizes Al for proactive energy management, reducing waste and ensuring devices are adequately powered.

### Operation and Use

Power Supply and Energy Storage: The PSU delivers power to the system through the System Bus. The BMS monitors energy levels and manages the charging of integrated batteries in each device. Devices draw power from stored energy, operating independently of continuous external power.

Real-Time Power Management: The BMS dynamically adjusts charging cycles based on real-time power demand and usage patterns. The mesh network enables real-time communication, allowing precise energy distribution.

Wireless Power Transfer: Supports scenarios where wired connections are impractical. Beam-forming technologies transfer energy wirelessly between devices. Photovoltaic receivers in devices capture and convert beam energy into usable power.

Integrated Safety Features: The Manual Logic Alert System continuously monitors for unauthorized or incompatible components. Alerts users to potential issues, preventing system overloads.

### AI-Driven Control: AI-Driven Control Hub

The Al-driven control hub is a central component of the system that oversees power distribution and management across all connected devices. This hub utilizes advanced Al algorithms to continuously monitor real-time usage data, allowing it to make informed decisions about power flow based on current demand and operational conditions.

### Al Modifications for Power Distribution

### Adaptive Learning

The Al algorithms are designed to learn from historical data and usage patterns.

By analyzing previous power consumption trends for each device, the control hub can predict future energy needs and adjust power distribution proactively.

For example, if the Al identifies that smart shades typically draw more power during specific times of day due to increased sunlight, it will preemptively allocate energy to those devices before peak demand occurs.

### Dynamic Resource Allocation:

The control hub employs a decision-making framework that dynamically reallocates power resources among devices based on real-time demands.

If a device experiences a sudden increase in power requirement-such as a portable electronic device entering a high-performance mode-the Al-driven control hub can prioritize power delivery to that device while managing the overall system load to maintain stability.

### Anomaly Detection:

The Al system is equipped with algorithms for detecting anomalies in power usage, such as unexpected spikes or drops in consumption.

When an anomaly is detected, the control hub can adjust power flow accordingly, preventing potential overloading of circuits and ensuring that only authorized devices receive power.

### Device Management and Alarm Features

The Al-driven control hub not only manages power distribution but also oversees device management and system integrity:

### Device Monitoring:

The control hub maintains a real-time inventory of all connected devices, continuously monitoring their power status and operational efficiency.

This ensures that devices operate within their specified power limits and are functioning as intended.

### Manual Logic Alert System:

The control hub communicates with the Manual Logic Alert System to provide notifications regarding system performance and potential issues.

If the Al detects unauthorized devices attempting to connect or abnormal power usage patterns, it triggers alerts to the user, detailing the nature of the issue and suggesting corrective actions.

The system can also initiate automated responses, such as temporarily isolating a problematic device from the network until further investigation can be conducted.

### User-Configurable Alerts:

Users can customize alert parameters based on their preferences, choosing to receive notifications for specific events, such as unauthorized access attempts or significant changes in power distribution.

This level of customization enhances user control and engagement with the system, fostering a proactive approach to energy management.

### CONCLUSION

By integrating advanced Al capabilities into the power distribution and management framework, the Al-driven control hub not only optimizes energy usage across connected devices but also enhances the overall security and integrity of the system. This innovative approach to energy management differentiates the technology from existing solutions, providing a compelling case for its patentability.

An Al-driven control hub oversees power distribution. The control hub continuously monitors real-time usage data and adjusts power flow based on demand. The control hub communicates with the Manual Logic Alert System to maintain system integrity.

Emergency Power Prioritization: In power shortages or emergencies, the system reallocates energy from non-critical to critical devices. Ensures essential devices continue functioning during high-demand or low-supply situations.

### Alternative Embodiments and Applications

The system is highly adaptable and can be configured for various applications beyond motorized shades.

Home Automation Systems: Manages power for devices such as security systems, lighting, HVAC controls, and entertainment systems. Enhances energy efficiency and reduces operational costs. Wireless charging capabilities simplify installation in areas where wiring is inconvenient.

Electric Vehicles (EVs): Scaled to manage charging cycles, power distribution, and energy storage in EVs. Optimizes battery performance based on driving patterns and available charging stations. Beam-forming power transfer enables wireless charging of auxiliary systems.

Marine and Recreational Vehicles (RVs): Manages onboard power systems, including navigation, communication, and amenities. Reduces the need for extensive wiring in mobile environments. Prioritizes critical systems during low power supply situations or emergencies.

Renewable Energy Systems: Integrates with solar or wind energy setups to optimize energy storage and distribution. BMS ensures stored energy is used efficiently during periods of low generation or high demand. Photovoltaic receivers maximize the use of clean energy in installations.

Industrial and Commercial Buildings: Manages power for security systems, machinery, and communication networks. Al-driven control hub prioritizes essential systems during high-demand periods. Enhances efficiency and ensures business continuity during power fluctuations.

### Customization and Scalability

The system is designed to be easily customized to meet specific power management requirements. By adjusting the size of the PSU, capacity of integrated batteries, and configuring the Al-driven control hub, the system can scale to accommodate various numbers of devices. The system offers a flexible and adaptable platform for efficient energy management across different sectors.

As may be appreciated, aspects of the subject technology provide several advantages including for example:

Efficient Power Distribution, by reducing energy waste by dynamically allocating power based on real-time demand. The system allows a smaller PSU to manage a greater power load, reducing the need for multiple large power supplies.

Dynamic Power Management, which uses an Al-driven BMS that optimizes charging cycles and prioritizes devices based on usage patterns. The power management ensures devices are charged during off-peak times, enhancing power availability during high-demand periods.

Flexible Charging Methods include supporting wired, wireless, and beam-forming charging, reducing installation complexity. The different charging methods enhance flexibility in device placement and infrastructure design.

Scalability and Adaptability: The system may be easily customizable to manage varying numbers of devices and power demands. Embodiments are applicable to residential, commercial, automotive, and marine environments.

Enhanced Safety Features, which include integrated safety mechanisms that prevent unauthorized device usage and system overloads. A Manual Logic Alert System ensures reliable and secure operation.

Wireless Energy Transfer is supported by using beam-forming technologies to enable efficient wireless power transfer. Wireless energy transfer reduces reliance on extensive wiring and facilitates flexible installations.

Al-Driven Efficiency provides continuous monitoring of power usage, adjusting flow based on real-time needs. The Al extends device lifespan and prevents overcharging.

As should be appreciated from the above-described elements, the Smart Power Distribution and Device Management System addresses the inefficiencies of traditional power management systems by integrating a Smart Battery Management System (BMS) that dynamically stores energy and schedules charging cycles. This innovation allows a single, smaller power supply (e.g., a 1-amp unit) to manage multiple devices that would typically require a larger combined load (up to 15 amps). By optimizing energy distribution, the system eliminates the need for bulky individual power supplies, simplifies installations, and minimizes energy waste. This results in a highly efficient power management system that supports multiple motorized shades or other low-power devices using a fraction of the energy usually required.

Existing systems often require dedicated power supplies or PoE switches for each device, leading to higher costs, complex installations, and inefficient continuous power consumption. The subject system eliminates the need for separate power supplies by allowing a single power supply to manage multiple devices through energy storage and dynamic power distribution.

The system operates by using a central PSU to distribute power across connected devices. The BMS continuously monitors each device's energy levels, scheduling charging cycles based on real-time demand and available power. Devices charge their integrated batteries during low-demand periods and operate independently during peak times, reducing continuous energy demand. The Mesh Network facilitates communication between the BMS and devices, allowing for real-time adjustments and preventing PSU overload. Flexible charging options enable adaptation to different installation environments.

The components in the system are highly configurable. The system can manage various low-power devices beyond motorized shades. The Beam-Forming Power Unit can be adjusted for different environments and distances providing flexible powering of devices. The PSU capacity and battery sizes may be adjusted which allows management of varying numbers of devices contributing to scalability.

End-use applications include: Automatic Management: BMS charges devices as needed, ensuring operation during peak demand; and Remote Monitoring: Users can monitor and control the system via a secure web interface.

The system may be adapted for other applications such as Home Automation: Managing power for smart home devices; Electric Vehicles (EVs): Managing larger battery systems and optimizing charging cycles; Renewable Energy Systems: Optimizing the use of solar or wind energy; Recreational Vehicles (RVs): Managing onboard power systems efficiently; Marine Applications: Managing power for boats or yachts; and Large Battery Setups: Efficiently managing large battery banks.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A power management system comprising:
A power supply unit (PSU) connected to a system bus;
A smart battery management system (BMS) that monitors and controls power distribution to multiple connected devices via the system bus;
Integrated energy storage units within each connected device, allowing operation independent of continuous external power;
Wherein the BMS utilizes adaptive AI algorithms to dynamically allocate power based on real-time demand, predictive usage patterns, and time-based management strategies, thereby optimizing charging cycles and preventing overloads;
Wherein the AI algorithms analyze historical usage data to forecast future energy requirements for each connected device, including specific timeframes when demand is expected to increase, enabling proactive adjustments to power distribution;
Wherein the BMS implements scheduled power allocation routines to prioritize critical devices during peak demand periods, effectively managing the distribution of power similar to grid management during heat waves;
Wherein the BMS employs anomaly detection mechanisms to identify unauthorized devices and manage power flow accordingly, maintaining system integrity and user-defined parameters.
